(19) United States
(12) Patent Application Publication
(10) Pub. No.: US 2016/0114870 A1
(43) Pub. Date: Apr. 28, 2016

(54) Surface Anti-Fouling Structure, Composition, and Method

(71) Applicant: John Kattine, Fort Walton Beach, FL (US)

(72) Inventor: John Kattine, Fort Walton Beach, FL (US)

(21) Appl. No.: 14/922,156

(22) Filed: Oct. 24, 2015

Related U.S. Application Data
(60) Provisional application No. 62/068,690, filed on Oct. 26, 2014.

(51) Int. Cl. B63B 59/00; C09D 5/16; C25D 3/38

(52) U.S. Cl. CPC B63B 59/00; C25D 3/38; C09D 5/1618

(57) ABSTRACT

An article surface anti-fouling structure, composition, and method includes a surface structure for encapsulating an article from an external environment, the structure having anti fouling properties protecting the article from the external environment. Also, a composition for applying to the surface of the article for the anti-fouling surface treatment of the article, the composition including copper sulfate, sulfuric acid, hydrochloric acid, umicore 836 brightener 1, umicore 836 leveler 1, and distilled water. In addition, a method for applying the composition to the surface includes steps of providing the composition, a container, an article, and an electrical power source, then creating an electrolyte bath from the composition. Additional steps include setting a bath temperature, immersing the article into the bath, charging the bath and the article for a galvanic deposition of the composition onto the article, controlling the galvanic deposition for a selected time, and removing the article from the bath.

### RELATED PATENT APPLICATION

This application claims the benefit of U.S. provisional patent application Ser. No. 62/068,690 filed on Oct. 26, 2014 by John Kattine of Fort Walton Beach, Fla., U.S.

### TECHNICAL FIELD

The present invention relates generally to surface treatments for the reduction in fouling upon the treated surface. More particularly, the present invention of the surface anti-fouling structure, composition, and method covers various ways to help prevent surface fouling build-up upon surfaces that are in an aquatic environment.

### BACKGROUND OF INVENTION

As is well known the fouling of marine submerged surfaces such as submerged structures, i.e. pipes, support structures, sensors, and the like, plus boat hulls and related parts such as rudders, propellers, and the like by marine organisms is highly undesirable due to physical damage and corrosion to the submerged surface, necessitating the required submerged surface cleaning of the rudder, propeller, and the like, being termed submerged boat surfaces, plus the added inefficiency due to increased water drag and boat weight, which increases boat fuel consumption from the fouling growth of hard and soft body marine organisms, particularly barnacles, also other organisms such as mussels, oysters, tubeworms, mollusks, hydroids, protozoans, algae, diatoms, hydrides, bryozoans, and annelids as typical examples. Wherein barnacles for instance can start growing on these submerged boat surfaces within a matter of days, plus given the fact that numerous larger boats tend to be moored at their docks for months at a time, adds even more toward fouling growth that accelerates in the more still water of the docking area, being particularly barnacles, this as opposed to smaller boats that typically spend their non-operational time out of the water, thus suspending the marine organism growth, wherein larger boats are continuously in the water except for occasional dry docking for maintenance, thus large boats having a majority of their time in the water which accelerates the growth of marine organisms.

In the prior art, a well-known way to prevent the buildup on marine organisms on submerged surfaces is to apply a special surface treatment in the form of a paint, however, the effectiveness of these paints is short term and not that good at preventing the marine organisms from growing, one of the major components of any of these prior art anti-fouling surface treatments is copper, zinc, and or lead in one form or another, so the effectiveness of including copper in some form in the surface treatment is key toward providing a functional antifouling underwater surface coating. Basically to stop or retard the marine organism growth, the submerged surface coating needs to have a toxic nature to repel the organic marine growth,

In looking at the prior art in this area, in U.S. Pat. No. 7,022,750 to Camp, et al., disclosed is an anti-fouling composition that comprises a film-forming resin with effective amounts of graphite and copper. In Camp, methods for using the compositions are also disclosed, as are substrates coated with the compositions. The coatings in Camp find particular application on substrates that are submerged for extended periods of time in salt water. Methods for promoting oyster cultivation are also disclosed. Camp claims that the use of graphite reduces the amount of copper required for effectiveness in helping to prevent submerged surface fouling, this as being more environmental as less copper is released into the environment this way, except for the prevention of oyster growth, thus the use of the Camp composition for oyster farming, i.e. that prevents other marine organisms from forming is applied.

Next, in the prior art in U.S. Pat. No. 4,895,881 to Bigner disclosed is an anti-fouling composition for coating on a surface intended to be submerged in water comprising a binder, from 1% to 50% of polytetrafluoroethylene particles, based on the dry weight of the composition, and from 5% to 95%, based on the dry weight of the composition, of an antifouling agent selected from the group consisting of copper metal, and copper, and zinc compounds, and also comprising a liquid dispersion medium, including at least one halogenated hydrocarbon, the polytetrafluoroethylene particles being dispersed in the liquid dispersion medium.

Further, in the prior art in U.S. Pat. No. 5,760,103 to Wentzell, disclosed is a marine cladding composition comprising in combination:

a. Copper powder b. Two epoxy resins
1. Bisphenol A epoxy resin and
2. Polyglycol di-epoxide

c. Glass fibers

d. Polydimethyl siloxane

e. Two amine curing agents
1. A polyammido amine and
2. An aliphatic amine

For Wentzell, this results in a claimed surface treatment that is hard and long lasting and minimizes the use of copper, which while having well known marine organism repelling properties causes galvanic corrosion with other marine structures due to copper's high nobility.

Continuing, in the prior art in U.S. Pat. No. 8,603,452 to Koob disclosed is a biological hydrogel that is chemically stabilized with non-covalent or covalent cross-links. The biological hydrogel in Koob is used to coat surfaces of materials for submersion in marine water. Molecular dissolution in Koob at the marine water-hydrogel surface prevents attachment of fouling organisms. The rate of dissolution in Koob can be controlled by both the concentration of the biopolymer in the hydrogel and the nature and concentration of cross-linker used. Additional components, either molecular or particulate in Koob, can be added to the biological hydrogel before or after cross-linking for enhanced properties.

Further, in the prior art in U.S. Patent Application Number 2011/0174207 to Harrick, et al., disclosed is a system that comprises towed marine seismic equipment, adapted for towing through a body of water; and a coating of copper particles via a cold spray process or gas plasma process covering the marine seismic equipment to protect from it from marine growth. A method in Harrick comprises towing marine seismic equipment having a coating of copper particles thereon to protect from marine growth while facilitating the seismic equipment normal functions.

There is of course no question for the need of marine submerged surface anti-fouling surface treatments, just the need for the treatments themselves in being effective to significantly reduce marine organism growth for a significant period of time, and be relatively easy and inexpensive to apply. There are particular submerged surfaces that are more difficult to treat due to their higher relative water velocities plus in some cases cavitation occurring being where gas pockets form on the propeller surface and then collapse from surrounding water pressure to in essence “pit” the propeller surface with high forces and eat away at any surface treatment that the propeller may have. Further, water force loads, such as on propellers, on propeller drive shafts, and on rudders, can act to erode surface treatments quickly, wherein these type surfaces are more difficult to surface treat with anti-fouling compositions due to their size, shape, and access issues, plus the surface treatments on these items is more difficult to get to adhere due to the previously mentioned higher relative water velocities and water forces, as opposed to the boat hull for instance. Thus this includes a surface anti-fouling structure, composition, and method that is specifically adapted for use in an aquatic environment

### SUMMARY OF INVENTION

Broadly, the present invention is for an article surface anti-fouling structure, composition, and method. The present invention thus includes a surface anti-fouling structure for encapsulating an article from an external environment, with the article having a terminating margin. The structure includes an enclosure having a longitudinal axis, the enclosure including a flexible surrounding sidewall that extends beyond the terminating margin to a sealing boundary, the surrounding sidewall completely encapsulates the article with the sealing boundary forming a communication as between the article and the external environment and a means for joining the sealing boundary to prevent the communication, thus to operationally isolate the article from the external environment.

Also, a composition for applying to the surface of the article for the anti-fouling surface treatment of the article, the composition including copper sulfate, sulfuric acid, hydrochloric acid, umicore 836 brightener 1, umicore 836 leveler 1, and distilled water. In addition a method for applying the composition to the surface of the article for an anti-fouling surface treatment of the article, the method includes the steps of providing a composition that includes a copper sulfate, a sulfuric acid, a hydrochloric acid, a umicore 836 brightener 1, a umicore 836 leveler 1, and distilled water. Further steps include providing a container, providing the article, providing an electrical power source, and creating an electrolyte bath from the composition, the container, and the electrical power source. Additional steps include setting a temperature of bath, immersing the article into the bath, charging the bath and the article for a galvanic deposition of the composition onto the article, controlling the galvanic deposition for a selected time, and removing the article from the bath having a resultant composition coating upon the article surface.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a front perspective view of the article, namely a propeller or screw that has been fouled with barnacles that grow upon all of the surfaces of the article;

FIG. 2 shows a front perspective view of a boat in water with several articles, namely a rudder and propeller, plus the propeller drive shaft all with fouling by barnacles that results in article surface damage, article corrosion, added weight to the boat, and higher article surface friction leading towards higher fuel consumption rates for the boat;

FIG. 3 is cross section 3-3 from FIG. 4, showing a cross section of the article or propeller blade with the deposited composition in a selected thickness layer upon the blade similar to a plating operation;

FIG. 4 shows a cross sectional view of the container that holds the composition in the form of an electrolyte bath, with the article immersed into the bath, wherein both the bath and the article are charged from an electrical power source to enable the galvanic deposition of the composition onto the surface of the article with controls on both temperature of the bath and time of article immersion into the bath, with the end result of the composition being in the selected thickness upon the article surface;

FIG. 5 shows a perspective view of a boat in dry dock with several articles, namely a rudder and propeller, plus the propeller drive shaft, with the rudder being enclosed with a flexible surrounding sidewall about a longitudinal axis to prevent communication as between the article or rudder in this case and the external environment thus protecting the article from fouling as the surrounding sidewall material has anti-fouling properties;

FIG. 6 is cross section 6-6 from FIG. 5 showing the article in the form of the rudder, the article surface, the article terminating margin all within the enclosure, the longitudinal axis, the flexible surrounding sidewall, an extension of the surrounding sidewall beyond the terminating margin forming a sealing boundary, wherein having initial communication as between the article and the external environment and further a means for joining the sealing boundary to prevent communication as between the article and the external environment, thus protecting the article from fouling as the surrounding sidewall material has anti-fouling properties;

FIG. 7 shows a side elevation view of a combination of articles being the propeller, the propeller drive shaft, and the support strut for the drive shaft all of the boat, wherein for the strut much the same as for the rudder as shown in FIG. 6, as the same cross section 6-6 is indicated, wherein the strut and the rudder all come under being the article, so for the strut the terminating margin is all within the enclosure, with the longitudinal axis, the flexible surrounding sidewall, and an extension of the surrounding sidewall beyond the terminating margin forming a sealing boundary, wherein having initial communication as between the article and the external environment, and further a means for joining the sealing boundary to prevent communication as between the article and the external environment, thus protecting the article from fouling as the surrounding sidewall material has anti-fouling properties, FIG. 7 also shows the article in the form of the propeller shaft that is encased within the enclosure in the form of the surrounding sidewall, with the terminating margin of the article; and

FIG. 8 shows cross section 8-8 from FIG. 7 for the article being in particular the propeller shaft that shows the longitudinal axis, the article surface, the enclosure, the flexible surrounding sidewall, the sealing boundary, and the means for joining the sealing boundary, wherein the article is protected from fouling as the surrounding sidewall material has anti-fouling properties and keep the external environment away from the shaft.

### REFERENCE NUMBERS IN DRAWINGS

50 Article

55 Surface of the article 50

60 Terminating margin of the article 50

65 External environment

66 Fouling matter

70 Enclosure structure

75 Longitudinal axis of the enclosure 70

80 Flexible surrounding sidewall of the enclosure 70 that encompasses the article 50 or alternatively a plurality of flexible surrounding sidewalls 80 that also in combination act to encompass the article 50

85 Extending beyond the terminating margin 60 of the surrounding sidewall 80

90 Sealing boundary of the surrounding sidewall 80

95 Communication as between the article 50 and the external environment 65

100 Means for joining the sealing boundary 90

105 Composition

110 Applying the composition 105 to the surface 55 of the article 50

115 Container

120 Electrical power source

125 Electrolyte bath

130 Immersing the article into the bath 125

135 Charging the bath 125 and the article 50

140 Galvanic deposition of the composition 105 onto the surface 55 of the article 50

145 Deposited composition 105 upon the surface 55 of the article 50

150 Thickness of the deposited composition 105 upon the surface 55 of the article 50

155 Clear coating

### DETAILED DESCRIPTION

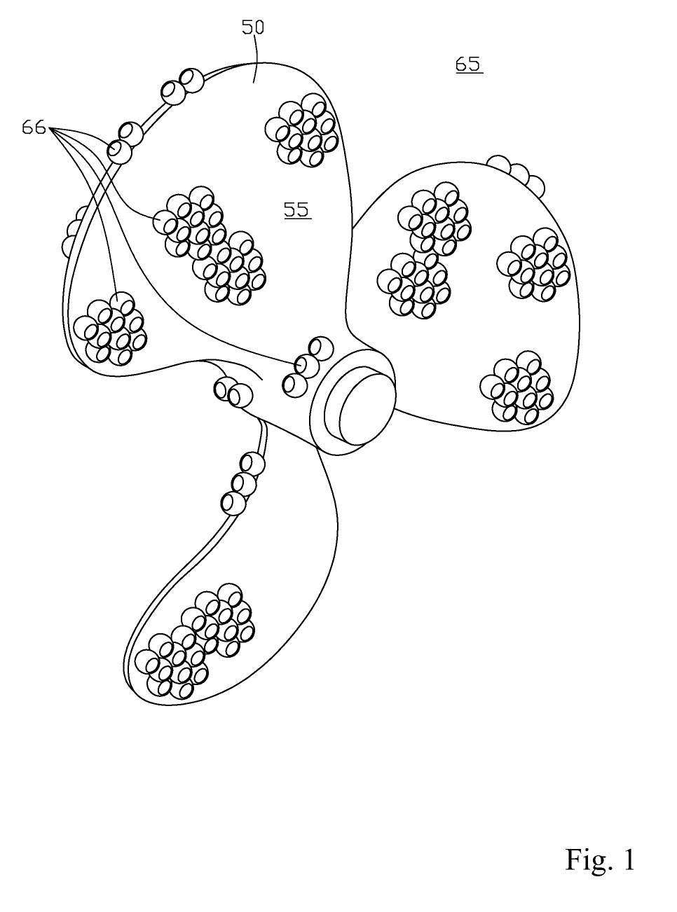

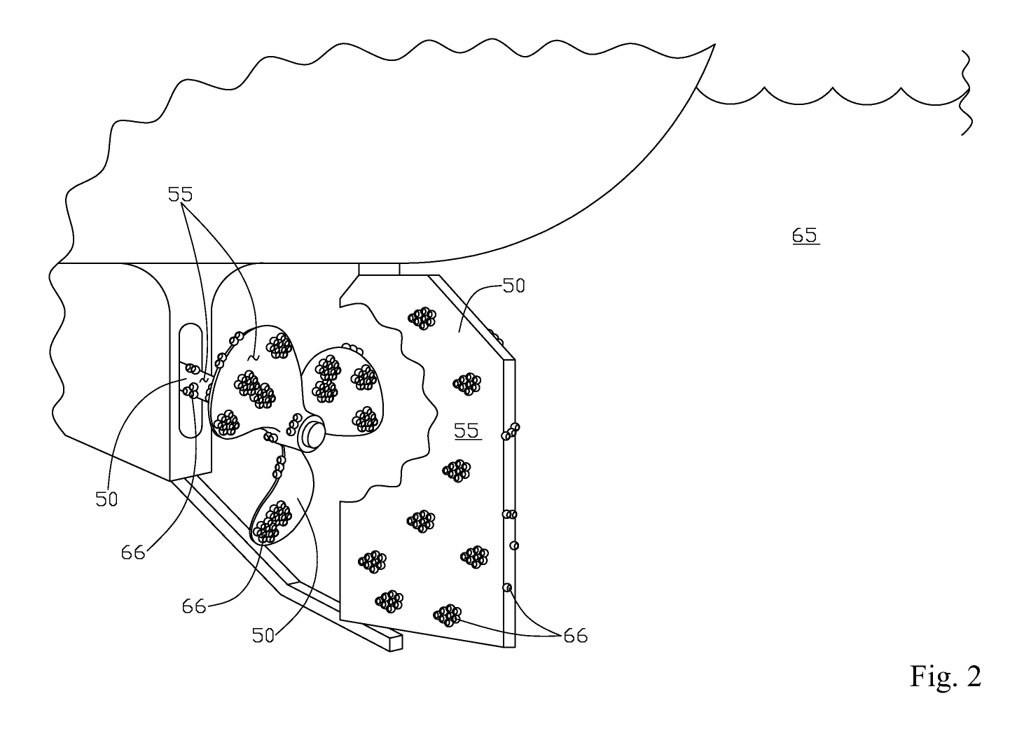

With initial reference to FIG. 1 shown is a front perspective view of the article 50, namely a propeller or screw that has been fouled 66 with barnacles from the external environment 65 that grow upon all of the surfaces 55 of the article 50. Next, FIG. 2 shows a front perspective view of a boat in water with several articles 50, namely a rudder and propeller, plus the propeller drive shaft all with fouling 66 being for example barnacles that results in article 50 surface 55 damage, article 50 corrosion, added weight to the boat, and higher article 50 surface 55 friction leading towards higher fuel consumption rates for the boat.

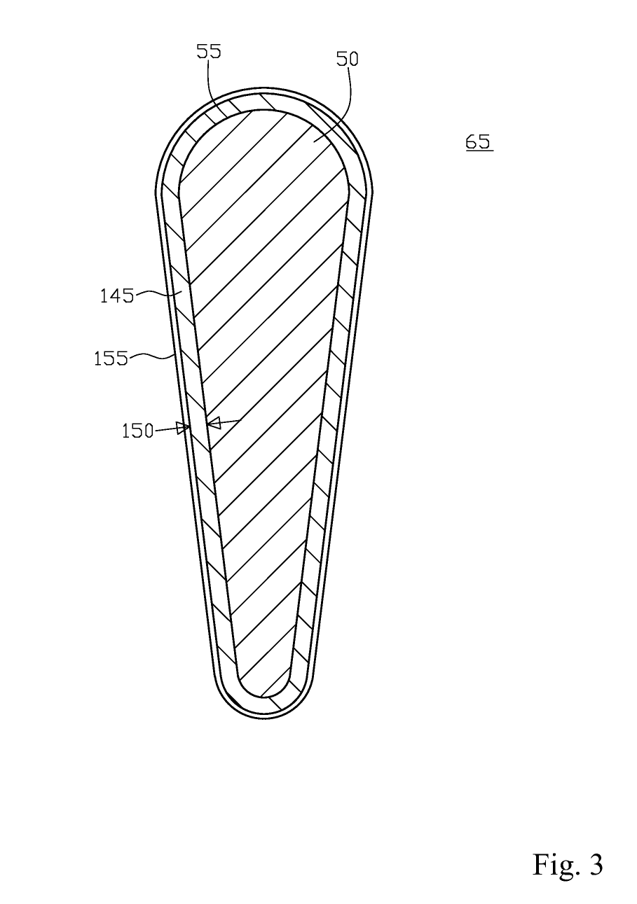

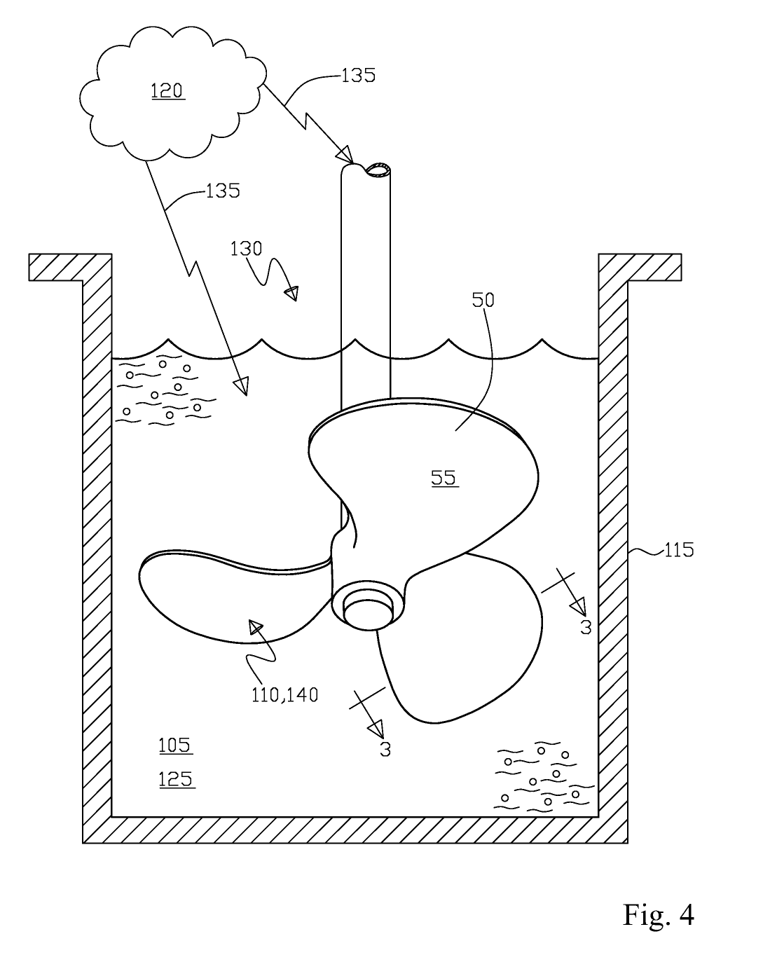

Continuing, FIG. 3 is cross section 3-3 from FIG. 4, showing a cross section of the article 50 or propeller blade with the deposited 140 composition 105 in a selected thickness 150 layer 145 upon the blade similar to a plating operation. Further, FIG. 4 shows a cross sectional view of the container 115 that holds the composition 105 in the form of an electrolyte bath 125, with the article 50 immersed 130 into the bath 125, wherein both the bath 125 and the article 50 are charged 135 from an electrical power source 120 to enable the galvanic deposition 140 of applying 110 the composition 105 onto the surface 55 of the article 50 with controls on both temperature of the bath 125 and time of article 50 immersion into the bath 50, with the end result of the composition 105 being in a selected thickness 150 upon the article 50 surface 55.

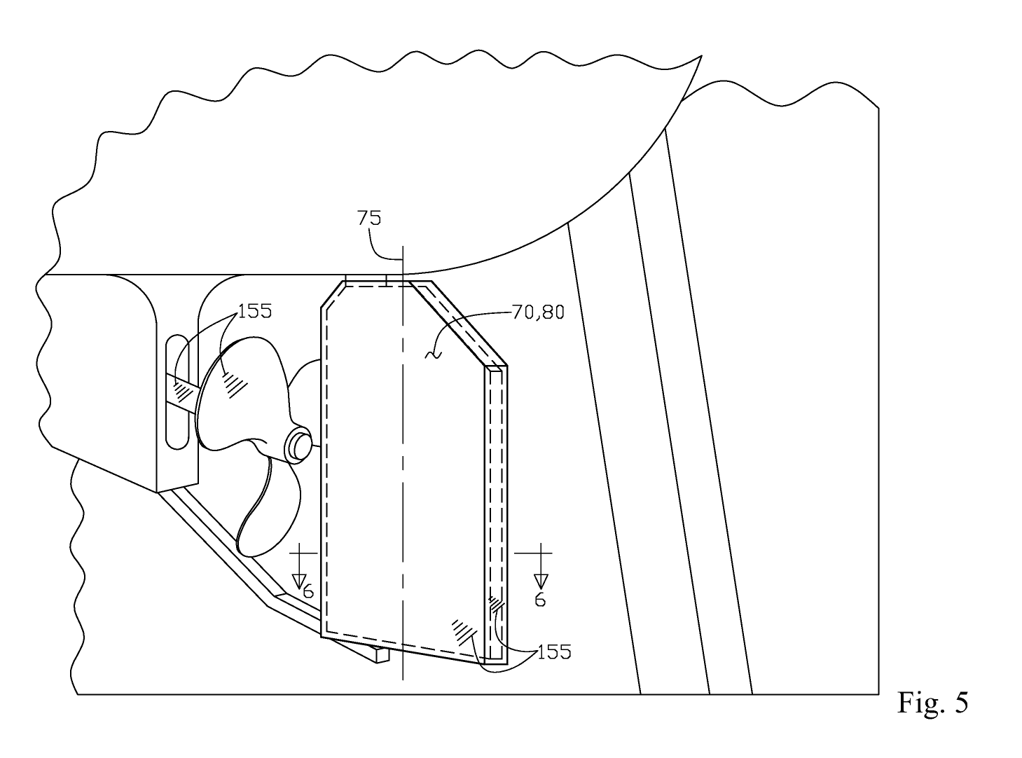

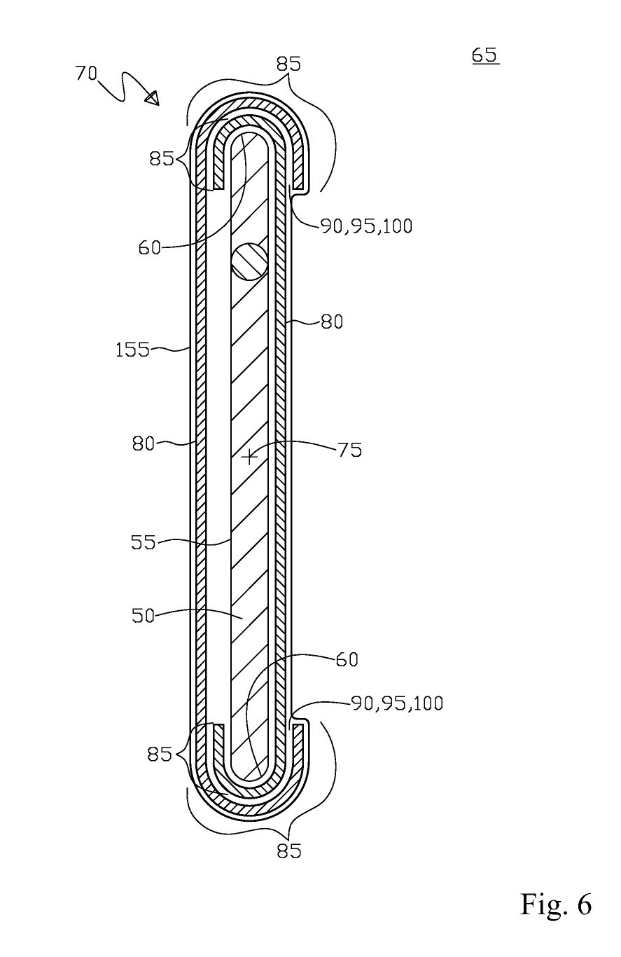

Next, FIG. 5 shows a perspective view of a boat in dry dock with several articles 50, namely a rudder and propeller, plus the propeller drive shaft, with the rudder being enclosed 70 with a flexible surrounding sidewall 80 about a longitudinal axis 75 to prevent communication 95 as between the article 50 or rudder in this case and the external environment 65 thus protecting the article 50 from fouling 66 as the surrounding sidewall 80 material has anti-fouling properties. Continuing, FIG. 6 is cross section 6-6 from FIG. 5 showing the article 50 in the form of the rudder, the article 50 surface 55, the article 50 terminating margin 60 all within the enclosure 70, the longitudinal axis 75, the flexible surrounding sidewall 80, an extension 85 of the surrounding sidewall 80 beyond the terminating margin 60 forming a sealing boundary 90. Further, FIG. 6 shows wherein having initial communication 95 as between the article 50 and the external environment 65 and further a means 100 for joining the sealing boundary 90 to prevent communication 95 as between the article 50 and the external environment 65, thus protecting the article 50 from fouling 66 as the surrounding sidewall 80 material has anti-fouling properties.

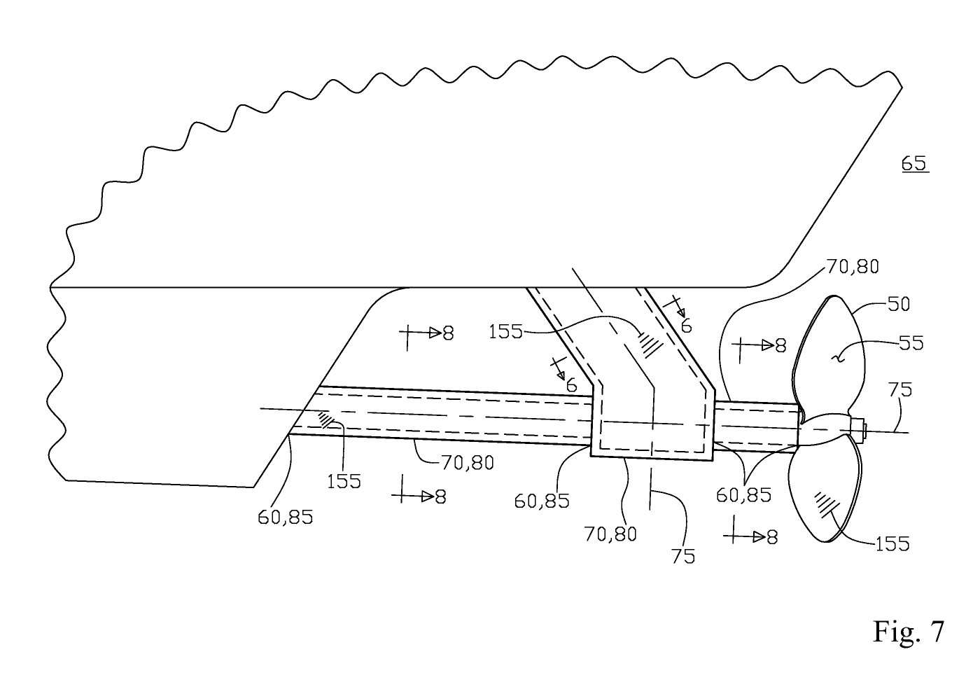

Moving onward, FIG. 7 shows a side elevation view of a combination of articles 50 being the propeller, the propeller drive shaft, and the support strut for the drive shaft, all of the boat, wherein for the strut much the same as for the rudder as shown in FIG. 6, as the same cross section 6-6 is indicated. Wherein, in FIG. 7, the strut and the rudder all come under being the article 50, so for the strut the terminating margin 60 is all within the enclosure 70, with the longitudinal axis 75, the flexible surrounding sidewall 80, and an extension 85 of the surrounding sidewall 80 beyond the terminating margin 60 forming a sealing boundary 90 much the same as the rudder shown in FIG. 6.

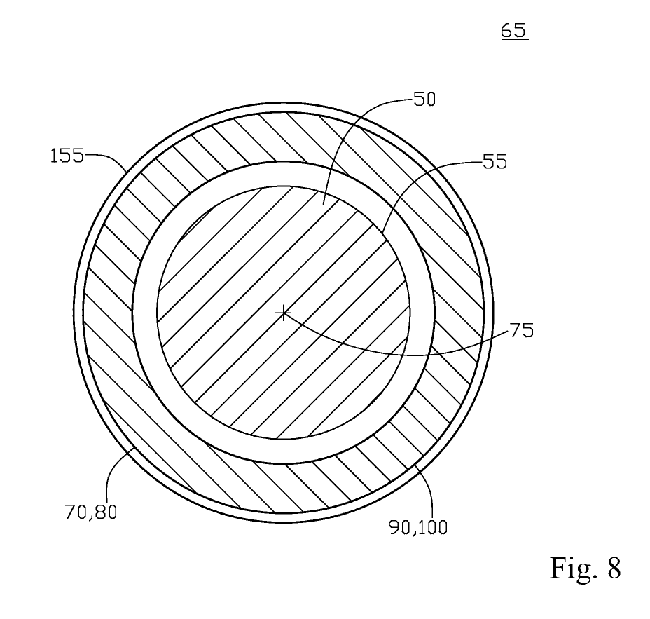

FIG. 7 also showing wherein having initial communication 95 as between the article 50 and the external environment 65 and further the means 100 for joining the sealing boundary 90 to prevent communication 95 as between the article 50 and the external environment 65, thus protecting the article 50 from fouling 66 as the surrounding sidewall 80 material has anti-fouling 66 properties. FIG. 7 also shows the article 50 in the form of the propeller shaft that is encased within the enclosure 70 in the form of the surrounding sidewall 80, and the terminating margin 60 of the article is shown. Next, FIG. 8 shows cross section 8-8 from FIG. 7 for the article 50 being in particular the propeller shaft that shows the longitudinal axis 75, the article 50 surface 55, the enclosure 70, the flexible surrounding sidewall 80, the sealing boundary 90, and the means 100 for joining the sealing boundary 90.

Broadly, the present invention of a surface anti-fouling structure, see FIGS. 5 to 8, the composition, see FIGS. 3 and 4, and the method, also see FIGS. 3 and 4. For the structure that includes a surface 55 anti-fouling 66 structure 70 for the encapsulating the article 55 from the external environment 65 that can be the water environment for the boat or the atmospheric environment 65 as applicable, and the article 50 having a terminating margin 60, see in particular FIGS. 6 and 7. The structure includes an enclosure 70 having the longitudinal axis 75, the enclosure 70 including a flexible surrounding sidewall 80 that extends beyond 85 the terminating margin 60 to the sealing boundary 90, see FIG. 6 in particular. The surrounding sidewall 80 completely encapsulates the article 50 with the sealing boundary 90 forming a communication 95 as between the article 50 and the external environment 65. The means 100 for joining the sealing boundary 90 to prevent the communication 95, being to operationally isolate the article 50 from the external environment 65, the means 100 is preferably via welding or a similar joining process. The enclosure 70 is preferably constructed of materials that resist fouling 66 such as copper based materials.

Optionally, for the surface 55 anti-fouling structure 70, the sealing boundary 90 communication 95 can be formed from an overlap of two partially co-incident flexible surrounding sidewalls 80 for ease of assembly to encapsulate the article 50, see FIG. 6. Further, optionally the means for joining 100 is preferably selected from the group consisting of welding, soldering, brazing, or a suitable equivalent, again see FIG. 6. Also, optionally the flexible surrounding sidewalls 80 are preferably constructed of copper based materials. Alternatively, for the flexible surrounding sidewall 80, it can optionally include a clear coat structure 155 disposed on a side of the flexible surrounding sidewall 80 that is opposite of the article 50 and faces the external environment 65 as an added antifouling layer, see FIGS. 3, 5, 6, 7, and 8. As another option the clear coat structure 155 can be applied solely to the article 50 surface 55 as the lone anti-fouling structure. The clear coat structure 155 is preferably made by the 3M company, part number F9469PCVHB, or a suitable equivalent.

Also, a composition 105 for applying to the surface 55 of the article 50 for the anti-fouling 66 surface 55 treatment of the article 50, the composition 105 including for a typical preferred batch of about 65 gallons total; about 58.3 kilograms of copper sulfate, about 7.9 liters of sulfuric acid, about 34.6 milliliters of hydrochloric acid, about 2.47 liters of umicore 836 brightener 1, about 1.97 liters of umicore 836 leveler 1, with the balance being about 57.5 gallons of distilled water. This results in the composition 105 comprising by volume about; six point six (6.6)% copper sulfate, three point one (3.1)% sulfuric acid, zero point zero one (0.01)% hydrochloric acid, one (1.0)% umicore 836 brightener 1, point eight (0.8)% umicore 836 leveler 1, and eighty eight point four nine (88.49)% distilled water, or for a typical batch of about sixty five (65) gallons that results in the composition 105 comprising by volume about; four point two nine (4.29) gallons of copper sulfate, two (2) gallons of sulfuric acid, point zero zero nine (0.009) gallons of hydrochloric acid, point six five (0.65) gallons of umicore 836 brightener 1, point five two (0.52) gallons of umicore 836 leveler 1, and fifty seven point five (57.5) gallons of distilled water.

In addition, the method 110 for applying the composition 105, preferably in an oxygen free manner, see FIGS. 3 and 4, to the surface 55 of the article 50 for an anti-fouling 66 surface 55 treatment of the article 50, the method includes the steps of providing the composition 105 as described above. Then further steps include providing the container 115, providing the article 50, providing the electrical power source 120 of preferably about 9 volts at 20 amps, and creating an electrolyte bath 125 from the composition 105, the container 115, and the electrical power source 120. Additional steps include setting a temperature of bath 125 of preferably about 90 degrees Fahrenheit, then immersing the article 50 into the bath 125, charging the bath 125 and the article 50 from the electrical power source 120 for a galvanic deposition 140 of the composition 105 onto the article 50 surface 55 as best shown in FIG. 3. Wherein, preferably the thickness 150 of the deposited composition 105 is about zero point zero three (0.03) inches, via controlling the galvanic deposition 140 for a selected time that is preferably about 48 hours, and then removing the article 50 from the bath with the result shown in FIG. 3.

Optionally, for the method 110 for applying the composition 105 to the surface 55 of the article 50, the composition 105 step can have the composition 105 comprising by volume about; six point six (6.6)% copper sulfate, three point one (3.1)% sulfuric acid, zero point zero one (0.01)% hydrochloric acid, one (1.0)% umicore 836 brightener 1, point eight (0.8)% umicore 836 leveler 1, and eighty eight point four nine (88.49)% distilled water, or for a typical batch of preferably sixty five (65) gallons that results in the composition 105 comprising by volume about; four point two nine (4.29) gallons of copper sulfate, two (2) gallons of sulfuric acid, point zero zero nine (0.009) gallons of hydrochloric acid, point six five (0.65) gallons of umicore 836 brightener 1, point five two (0.52) gallons of umicore 836 leveler 1, and fifty seven point five (57.5) gallons of distilled water.

Further, optionally, for the method 110 for applying the composition 105 to the surface 55 of the article 50 wherein the creating an electrolyte bath 125 step is configured via the container 115 to preferably provide an oxygen free environment for the immersing 130 of the article 50 into the bath 125 step, such that atmospheric air oxygen is not substantially present in the bath being adjacent to the article 50 for enhancing the depositing 145 of the composition 105 onto the surface 55 of the article 50, see FIG. 4. In addition, optionally for the method for applying the composition 105 to the surface 55 of the article 50, wherein for the providing an electrical power source step the electrical power source is preferably about nine (9) volts at twenty (20) amps. Alternatively, for the method for applying the composition 105 to the surface 55 of the article 50, wherein the setting of a temperature of the bath 125 step has the bath 125 temperature preferably set to about ninety (90) degrees Fahrenheit.

Another option for the method 110 for applying the composition 105 to the surface 55 of the article 50, wherein the controlling the galvanic composition 105 deposition 140 for a selected time step has a selected time of preferably being about forty eight (48) hours. In conjunction with this, optionally for the method 110 for applying the composition 105 to the surface 55 of the article 50, can further comprise a step of confirming a thickness 150 of the composition 105 that is deposited upon the article 50 surface 55, with the thickness 150 being preferably about thirty thousandths (0.030) of an inch, see FIG. 3.

### CONCLUSION

Accordingly, the present invention of a surface anti-fouling structure, composition, and method has been described with some degree of particularity directed to the embodiments of the present invention. It should be appreciated, though; that the present invention is defined by the following claim construed in light of the prior art so modifications or changes may be made to the exemplary embodiments of the present invention without departing from the inventive concepts contained therein.

1. A surface anti-fouling structure for an encapsulating an article from an external environment, the article having a terminating margin, said structure comprising:
(a) an enclosure having a longitudinal axis, said enclosure including a flexible surrounding sidewall that extends beyond the terminating margin to a sealing boundary, said surrounding sidewall completely encapsulates the article with said sealing boundary forming a communication as between the article and the external environment; and
(b) a means for joining said sealing boundary to prevent said communication to operationally isolate the article from the external environment.

2. A surface anti-fouling structure according to claim 1 wherein said sealing boundary communication is formed from an overlap of two partially co-incident flexible surrounding sidewalls.

3. A surface anti-fouling structure according to claim 2 wherein said means for joining is selected from the group consisting of welding, soldering, and brazing.

4. A surface anti-fouling structure according to claim 3 wherein said flexible surrounding sidewalls are constructed of copper based materials.

5. A surface anti-fouling structure according to claim 2 wherein said flexible surrounding includes a clear coat structure disposed on a side of said flexible surrounding sidewall that is opposite of the article and faces the external environment.

6. A composition for applying to a surface of an article for an anti-fouling surface treatment of the article, said composition comprising:
(a) copper sulfate;
(b) sulfuric acid;
(c) hydrochloric acid;
(d) umicore 836 brightener 1;
(e) umicore 836 leveler 1; and
(f) distilled water.

7. A composition according to claim 6 wherein said composition comprising by volume about:
(a) 6.6% copper sulfate;
(b) 3.1% sulfuric acid
(c) 0.01% hydrochloric acid
(d) 1.0% umicore 836 brightener 1;
(e) 0.8% umicore 836 leveler 1; and
(f) 88.49% distilled water.

8. A method for applying a composition to a surface of an article for an anti-fouling surface treatment of the article, said method comprising the steps of:
(a) providing a composition that includes a copper sulfate, a sulfuric acid, a hydrochloric acid, a umicore 836 brightener 1, a umicore 836 leveler 1, and distilled water;
(b) providing a container;
(c) providing the article;
(c) providing an electrical power source;
(d) creating an electrolyte bath from said composition, said container, and said electrical power source;
(e) setting a temperature of said bath;
(e) immersing the article into said bath;
(f) charging said bath and the article for a galvanic deposition of said composition onto the surface of the article;
(g) controlling said galvanic deposition for a selected time; and
(h) removing the article from said bath.

9. A method for applying a composition according to claim 8 wherein said providing a composition step has said composition comprising by volume about; 6.6% copper sulfate, 3.1% sulfuric acid, 0.01% hydrochloric acid, 1.0% umicore 836 brightener 1, 0.8% umicore 836 leveler 1, and 88.49% distilled water.

10. A method for applying a composition according to claim 9 wherein said creating an electrolyte bath step is configured via said container to provide an oxygen free environment for said immersing the article into said bath step.

11. A method for applying a composition according to claim 10 wherein said providing an electrical power source step is an electrical power source being about nine (9) volts at twenty (20) amps.

12. A method for applying a composition according to claim 11 wherein said setting a temperature of said bath step has said bath temperature set to about ninety (90) degrees Fahrenheit.

13. A method for applying a composition according to claim 12 wherein said controlling said galvanic deposition for a selected time step has said selected time at about forty eight (48) hours.

14. A method for applying a composition according to claim 13 further comprising a step of confirming a thickness of said composition that is deposited upon the article surface, with said thickness being about thirty thousandths (0.030) of an inch.
